(19) United States
(12) Patent Application Publication
(10) Pub. No.: US 2025/0096312 A1
(43) Pub. Date: Mar. 20, 2025

(54) Engineering of glass-ceramic solid-state electrolytes with antiperovskite crystal structure in the microwave radiation environment

(71) Applicant: South Dakota Board of Regents, Pierre, SD (US)

(72) Inventors: Alevtina Smirnova, Rapid City, SD (US); Karen Ly, Rapid City, SD (US); Kamden Bryant, Kearney, NE (US); Collin Rodmire, Rapid City, SD (US); Fan Zheng, Rapid City, SD (US)

(73) Assignee: South Dakota Board of Regents, Pierre, SD (US)

(21) Appl. No.: 18/889,068

(22) Filed: Sep. 18, 2024

Related U.S. Application Data
(60) Provisional application No. 63/583,714, filed on Sep. 19, 2023.

(51) Int. Cl. H01M 10/0562

(52) U.S. Cl. CPC H01M 10/0562; H01M 2300/0071

(57) ABSTRACT

The disclosed invention is related to microwave radiation as a method for the synthesis metal-ion solid-state electrolytes from the group known as antiperovskites or inverse perovskites, and more specifically doped or andoped antiperovskites and the use of microwave radiation to synthesize solid-state oxyhalide electrolytes or their doped derivatives with enhanced metal-ion conductivity resulting in higher purity at a lower cost and applicable for large-scale commercial applications.

### PRIORITY STATEMENT

This application claims priority to U.S. Provisional Patent Application No. 63/583,714 filed on Sep. 19, 2023, titled Engineering of glass-ceramic solid-state electrolytes with antiperovskite crystal structure in the microwave radiation environment, all of which is hereby incorporated by reference in their entirety.

### STATEMENT REGARDING FEDERALLY FUNDED RESEARCH

This invention was made with government support from the NSF IUCRC Center for Solid-State Energy Storage (Grants #2052631, #2052796, and #2052611) and the South Dakota Governor's Research Center for Electrochemical Energy Storage (2021-2026).

### FIELD OF THE DISCLOSURE

The present disclosure is related to the materials engineering of solid-state metal-ion battery components, specifically to inorganic solid-state electrolytes that can be produced with high purity and in a short period of time using microwave radiation.

### BACKGROUND

The present disclosure is related to metal-ion solid-state electrolytes from the group known as antiperovskites or inverse perovskites, and more specifically doped or andoped antiperovskites with a general formula of M3LX, where M is an alkali metal cation, for example Li, Na, or K, L is a chalcogen, for example O or S, and X is a halogen such as chlorine, bromine, or iodine. This group of materials has an advantage of high ionic conductivity, wide electrochamical stability window, cost-effictive synthesis from inorganic precursors, and electrochemical stability in contact with metal anodes. The disclosed invention is focused on microwave radiation as a method for synthesis of these superionic conductors.

Metal-ion solid-state electrolytes, such as lithium (Li₃OX, X=Cl, Br, I) or sodium oxyhalides (Na₃OX, X=Cl, Br, I), have the advantage of high ionic conductivity and inexpensive inorganic precursors. This disclosure is related to microwave radiation as a method for the synthesis of alkali-ion superionic conductors, and more specifically lithium or sodium-ion conductors. The disclosure is specifically demonstrated for Na₃OCl as a baseline material produced in a short period of time with high-purity using microwave radiation. The weight loss, melting point, and phase transformations were evaluated by the thermogravimetric analysis. The ionic conductivity of Na₃OCl was tested between 160° C. and 200° C. using electrochemical impedance spectroscopy. The Arrhenius behavior of this material allowed calculations of ionic conductivity and activation energy for sodium-ion transport. The purity of as-synthesized powders was evaluated using X-ray diffraction and electrochemical impedance spectroscopy. This study's novelty is in using a microwave radiation to synthesize solid-state oxyhalide electrolytes or their doped derivatives with enhanced metal-ion conductivity. Compared to other methods, this method results in higher purity at a lower cost and can be scaled up for large-scale commercial applications.

Therefore, what is needed is a microwave radiation system and method for synthesizing higher purity glass ceramic solid-state electrolytes.

### SUMMARY

Therefore, it is a primary object feature, or advantage of the present disclosure to improve over the state of the art.

It is a further object, feature, or advantage of the present disclosure to synthesize high purity solid-state electrolytes at low cost.

It is a still further object, feature, or advantage of the present disclosure to synthesize solid-state electrolytes with enhanced metal-ion conductivity.

Another object, feature, or advantage of the present disclosure is to synthesize doped derivatives of solid-state electrolytes.

Yet another object, feature, or advantage of the present disclosure is the presence of a sodium-ion charge transfer in a broad temperature range, and preferably below 160° C., and even more preferably below the melting point of sodium metal (97.79° C.).

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

In one aspect of the present disclosure, a microwave radiation system for synthesizing glass ceramic solid-state electrolyte is disclosed. The microwave radiation system may include at least two solid-state electrolyte precursors and a weight of each of the at least two precursors adjusted by a stoichiometric ratio of the at least two precursors. The microwave radiation system may further include a container for combining the at least two precursors to form a powder from the at least two precursors. The microwave radiation system may further include a crucible for holding the powder; and a microwave for heating the crucible to form a solid-state electrolyte material.

In another aspect of the present disclosure, another microwave radiation system for synthesizing glass ceramic solid-state electrolyte is disclosed. The microwave radiation system may include at least two solid-state electrolyte precursors, wherein the precursors may be ground to a powder. The microwave radiation system may include a crucible for holding the powder. The microwave radiation system may further include a microwave for heating the crucible holding the powder by applying microwave radiation at a controlled temperature range for a time period, wherein the heating may transform the powder into a solid-state electrolyte material and a gas glovebox housing the microwave; the gas glove box may supply gas to an interior of the gas glove box.

In another aspect of the present disclosure, a method for synthesizing glass ceramic solid-state electrolyte utilizing microwave radiation is disclosed. The method may include weighing at least two solid-state electrolyte precursors. The method may further include combining the at least two solid-state electrolyte precursors in a container with a grinding media. The method may also include grinding the at least two solid-state electrolyte precursors to form a powder and transferring the powder to a crucible. The method may include microwaving the crucible in a microwave, wherein a frequency of the microwave may be tuned to form a product, and sifting the product to form a solid-state electrolyte material. The method may also include transferring the solid-state electrolyte material to a pellet die, placing a foil in the pellet die, and heating the pellet die while applying pressure to the solid-state electrolyte and foil to combine the solid-state electrolyte and foil to form a positive electrode. Lastly, the method may include placing the positive electrode in a cell and placing a negative electrode in the cell.

### BRIEF DESCRIPTION OF THE DRAWINGS

Illustrated aspects of the disclosure are described in detail below with reference to the attached drawing figures, which are incorporated by reference herein.

FIG. 1 illustrates a microwave radiation system for synthesis of glass-ceramic solid-state halide and oxyhalide electrolytes in accordance with one aspect of the present disclosure.

FIG. 2 illustrates the XRD spectrum of Na₃OCl synthesized using a vacuum environment or using microwave radiation without adjustment in accordance with one aspect of the present disclosure.

FIG. 3 illustrates XRD pattern for Na₃OCl synthesized by using microwave radiation in accordance with one aspect of the present disclosure.

FIG. 4 illustrates an equivalent circuit for symmetrical pouch cell with Na₃OCl solid-state electrolyte and graphite-coated copper foil as blocking electrodes in accordance with one aspect of the present disclosure.

FIG. 5 illustrates AC impedance data of microwave-synthesized Na₃OCl at various temperatures in symmetric Na₃OCl pouch cells.

FIG. 6 illustrates Arrhenius plot for vacuum-synthesized Na₃OCl in symmetric pouch cell with carbon-coated copper foil as the blocking electrodes.

FIG. 7 illustrates Arrhenius plot for the microwave-synthesized Na₃OCl in symmetric pouch cell with carbon-coated copper foil as the blocking electrodes in accordance with one aspect of the present disclosure.

FIG. 8 is a flowchart illustrating one method of utilizing the microwave radiation system to synthesize glass ceramic solid-state electrolytes in accordance with one aspect of the present disclosure.

### DETAILED DESCRIPTION

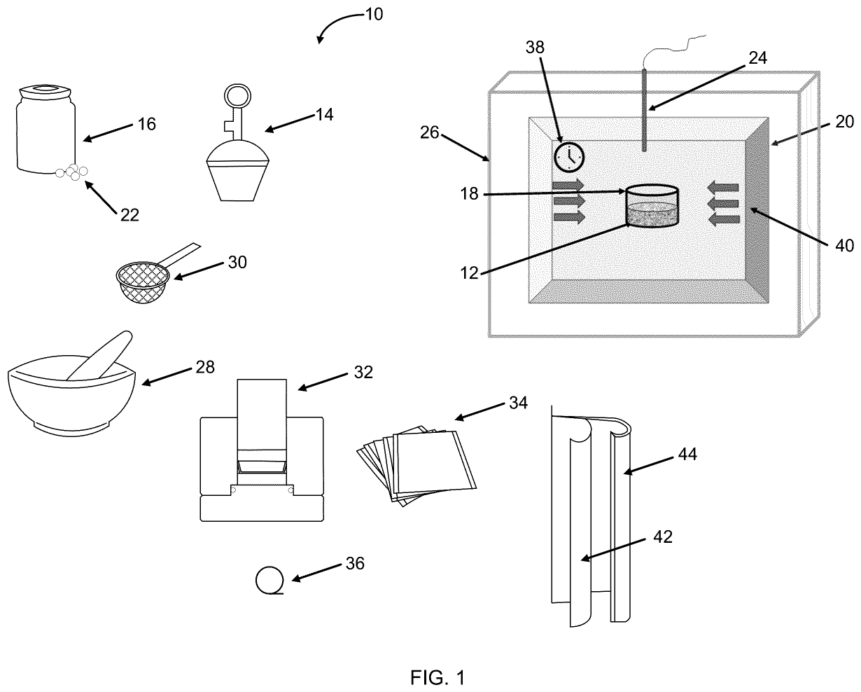

FIGS. 1-8 provide various pictorial illustrations for exemplary aspects in accordance with the objects, features, and advantages of the present disclosure.

The present disclosure contemplates many different apparatuses and varying arrangements, methods and systems for synthesizing glass ceramic solid-state electrolyte as well as commercialization and use. Representative applications of methods and systems are described in this section as well as apparatus mechanisms and structures. These examples are provided solely to add context and aid in understanding of the described aspects of the disclosure. It will thus be apparent to one skilled in the art that the described aspects of the disclosure may be practiced without some and/or all of these specific details. In other instances, well known process steps have not been described in detail in order to avoid unnecessarily obscuring the described aspects. Other applications are possible, such that the following examples should not be taken as limiting.

In the following detailed description, references are made to the accompanying drawings, which form a part of the description and show, by way of illustration, specific aspects in accordance with the methods and systems of the present disclosure. Although aspects of the disclosure are described in sufficient detail to enable one skilled in the art to practice the described aspects, it is understood that these examples are not limiting; other aspects may be used, and changes may be made without departing from the spirit and scope of the described aspects of the disclosure.

It will also be understood that, although the terms first, second, next, lastly, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects of the disclosure only and is not intended to be limiting of the present disclosure. As used in the description of the apparatus, system, and method as well as the appended claims, the singular forms “a”, “an” and “the” are intended to include the plural forms as well, unless the context clearly indicates otherwise. By way of example only, while the singular form of numerous components and steps are described in various aspects of the disclosure herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if” may be construed to mean “when” or “upon” or “in response to determining” or “in response to detecting,” depending on the context.

An alternative path to lithium-ion battery technology is in the development of solid-state sodium-ion batteries. Compared to lithium metal, sodium metal is inexpensive and can be easily produced. These benefits combined with similar chemical and ionic transport mechanisms between lithium- and sodium-ions, make sodium-ion batteries a good alternative for large-scale energy grid storage and potential for use in electric vehicles with low carbon footprint. In addition to lower resource costs and environmental benefits, solid-state batteries completely remove the risk of flammability by replacing organic and polymer-based liquid electrolytes with non-flammable solids. The solid-state electrolyte (SSE) can also serve as a separator between the anode and cathode preventing extensive sodium dendrite growth which can result in short-circuits. For these reasons, sodium-ion batteries may be able to compete with their lithium-ion counterparts in terms of cost and sustainability.

Among sodium-ion solid-state electrolytes, three major groups have been extensively studied, among them chalcogenides (primarily sulfide-based), sodium (Na) superionic conductors (NASICONs), and more recently, antiperovskites and perovskites. Sodium oxyhalides present a new group in sodium-ion solid-state electrolyte development. Like lithium-based antiperovskites, sodium-based materials such as Na₃OCl, Na₄OBr₂, and Na₃SO₄F adopting antiperovskite or intergrowth antiperovskite structures have been studied.

Antiperovskites have advantages in terms of their composition that can be easily tuned by ionic doping leading to greater electrochemical stability, good mechanical ductility, and formation of glass-ceramic phases with high ionic conductivity in the solid-state electrolytes.

It was shown that doping of base structures like Na₃OX (X=Cl, Br, I) may improve the total ionic conductivity at room temperature by two orders of magnitude. For example, Na_{2.9}Sr_{0.05}OBr_{0.6}I_{0.4} was produced by a solid-state reaction at 350° C. resulting in ionic conductivity of 1.9×10⁻³ S cm⁻¹ at 200° C. An increase in ionic conductivities from Na₃OCl to Na₃OBr and then to iodine-mixed Na₃OBr_{0.6}I_{0.4} was explained by the mismatching effect of halogen ions in A-sites, where alternating Br and I anions in the dodecahedral A-sites provide more free space for Na-ions to move through interstitial pathways. It was assumed that divalent doping, e.g. with Sr²⁺ in Na⁺, sites could introduce more vacancies thus increasing effective diffusion pathways and higher sodium-ion conductivity.

Attempts were made to reproduce the results from several articles published in the last decade of research. However, the synthesis of these materials is performed by solid-state synthesis which often results in high-cost and different purity of the material. This disclosure presents a new approach in synthesis of this large group of sodium-based antiperovskite solid-state electrolytes materials using microwave radiation with operating frequencies in the range of 300 GHz to 300 MHz, or more specifically 2.45 GHz. Subjected to oscillating microwave radiation, vibrations of polar antiperovskite molecules or their inorganic precursors could result in well-dispersed localized heating and more effective heat distribution compared to traditional solid-state sintering.

In the past, microwave sintering has been used for synthesis of numerous solid-state materials and ceramic electrolytes, for example, Na₃Zr₂Si₂PO₁₂ (NZSP), In this example, uniform microwave heating at 850° C. for 30 minutes resulted in 96% dense NZSP phase and 2.511×10⁻⁴ S cm⁻¹ ionic conductivity which is comparable to the conductivity of material synthesized by solid-state sintering but at much higher temperature (1200° C.) and for longer time (720 minutes). However, it has never been demonstrated for glass-ceramic solid-state electrolytes, such as lithium or sodium halides or oxyhalides. By tuning the microwave frequency, an optimal heating could be achieved in less time resulting in higher density, higher yield, and lower carbon footprint.

### Experimental

### Materials Synthesis

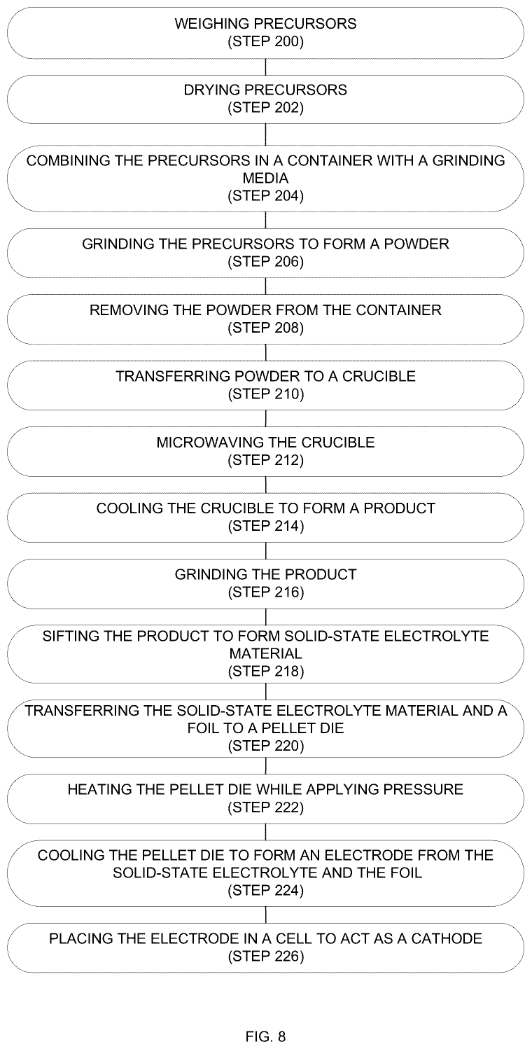

FIG. 1 illustrates a microwave radiation system 10 for synthesizing glass ceramic solid-state electrolytes. All precursors 12, including solid-state electrolyte inorganic precursors, may be weighed under argon with the moisture and oxygen content kept at a minimum (such as <0.1 ppm and <1 ppm, respectively) or at a first moisture content and a first oxygen content (Step 200) as shown in FIG. 8. FIG. 8 illustrates a method for utilizing the microwave radiation system for synthesizing glass ceramic solid-state electrolytes. Precursors 12 may be dried in a vacuum desiccator 14 overnight at a drying temperature such as, 120° C. (Step 202). Precursors 12, such as 1.6334 g of Na₂O (Sigma Aldrich, 80% assay) and 1.3504 g of NaCl (Sigma Aldrich, 99.9% assay) may be combined in a container 16 such as a 50 mL yttria-stabilized ZrO₂ ball mill jar with a grinding media 22 (Step 204). In some examples, 30 g of 5-mm ZrO₂ grinding media was used. The precursors may be ground for 1 hour at 600 rpm to form a powder, the grinding time may be longer or shorter than an hour and the RPM speed may be higher or lower than 600 rpm (Step 206). After 30 minutes of effective grinding, the container 16 or ball mill jar may be scraped down under argon or another gas and the powder is removed (Step 208). The effective grinding time may be longer or shorter. The powder or ball-milled powder may be transferred to a crucible 18 (Step 210) or an alumina crucible and microwaved at a certain temperature range and for a certain time period in a microwave 20 or a furnace chamber (Step 212) utilizing oscillating radiation. The microwave may have a timer 38. The temperature may be controlled using a temperature sensor 24. A gas may be used during the microwave process. The powder may be microwaved in the temperature range of 350-450° C. for 1 hour under nitrogen. The microwave set up may include a gas glovebox 26 containing the microwave 20 or other elements of the microwave radiation system. The gas glovebox 26 may be an argon glovebox or a nitrogen glovebox. The crucible 18 may be immediately removed from the microwave 20 for fast cooling (Step 214). Next, the resulting product, solid-state electrolyte material, may be hand-ground in a grinder 28 such as mortar (Step 216). The resulting product may be moisture sensitive.

### Materials Characterization

X-ray diffraction (XRD) data was collected at room temperature (25° C.) on a Malvern PANalytical Empyrean diffractometer with a cobalt excitation source (λ=1.78899 Å, 40 kV, 45 mA). The samples of the resulting product were prepared under dry argon atmosphere to avoid moisture contamination.

A thin Kapton tape (5 μm) or another polyimide tape with adhesive may be used to cover the moisture-sensitive material during XRD data collection. The Kapton tape may contribute a broad peak over the 20° to 25° range and may be removed during phase analysis using the MDI Jade software. In one example, to determine the Na₃OCl morphology and chemical composition, an SEM/EDS analysis was performed using Helios 5 DualBeam-FIB-SEM from ThermoFisher Scientific.

In one example, the TGA analysis was performed with a scan rate of 5° C. per min in ultra-high purity argon. Further in one example, to avoid moisture contamination, the sample (7 mg) was loaded in a boat inside the argon glove box and then transferred to the TGA analyzer under argon flow.

### Electrochemical Cell Fabrication

The produced solid-state electrolyte material may be ground and sifted through using a sifter 30, such as a mesh or a 38 μm mesh, under dry argon atmosphere or a dry nitrogen atmosphere (Step 218). A sample of Na₃OCl powder (0.12 g) or produced solid-state electrolyte material may be weighed under dry nitrogen or dry argon and transferred to a pellet die 32 with a disk of foil 34, such as Cu/graphite or Al/graphite foil (Step 220). The foil 34 may be weighted, and the thickness may be measured using a micrometer. The pellet die 32 was heated using a heating tape 36 and the pressure was gradually increased to a first pressure, such as to 6 tons (6T/m²=0.059 MPa), during its heating (Step 222). The heating may be within the temperature range 250° C.-300° C. or at higher or lower temperature ranges. The first pressure may be higher or lower. The pressure and heat may be held for a time period, such as 30 min. The heat tape 36 may be removed, and the pellet die 32 may be allowed to cool while under pressure (Step 224). The resulting foil-solid-state electrolyte material assembly 42 may be weighted, and the thickness may be measured. The foil-solid-state electrolyte material assembly 42 or foil with deposited cathode layer may be used as the positive electrode and a metal foil, such as a Na metal foil served as the negative electrode 44, in a coin cell or pouch cell configuration or split cell from MTI (Step 226).

### Electrochemical Analysis

In one example, AC impedance measurements were conducted using a 1260 Solartron analyzer. The real and imaginary data was sampled with 30 points taken over a frequency range of 0.1 Hz to 30 MHz and an AC amplitude of 10 mV. The CR2016 half-cells were tested from room temperature to 90° C. to determine the optimized temperature range for further C-rate cycling and cyclic voltammetry tests.

Cyclic voltammetry (CV), rate capability, and cyclability tests were conducted using the Arbin test station in one example. The tests at elevated temperatures utilized environmental chambers with temperature controllers to maintain the specific temperature required for each experiment.

In one example, to evaluate the electrochemical stability window, cyclic voltammetry (CV) tests were performed at a scan rate of 0.1 mV/s and voltage range of 0.05 V to 5.0 V for 5 complete cycles in a half-cell or split cell configuration.

In one example, galvanostatic charge/discharge cycling of CR2016 half- or split-cells was performed in the temperature range of 25° C.-100° C. The C-rate was calculated based on the weight of carbon/graphite layer on the copper foil and further tuned after a few initial cycles. To observe the effect of temperature on cell performance, two sets of the C-rate capability tests were performed at 50° C. and 100° C.

### Results and Discussion

The known synthesis methods of glass-ceramic electrolytes, and specifically sodium oxyhalides (Na₃OX, X=Cl, Br, I) from inorganic precursors in vacuum, demonstrate many challenges in reaching high purity at low cost. This synthesis requires a complicated set-up and extended heating time reaching 5-10 hrs.

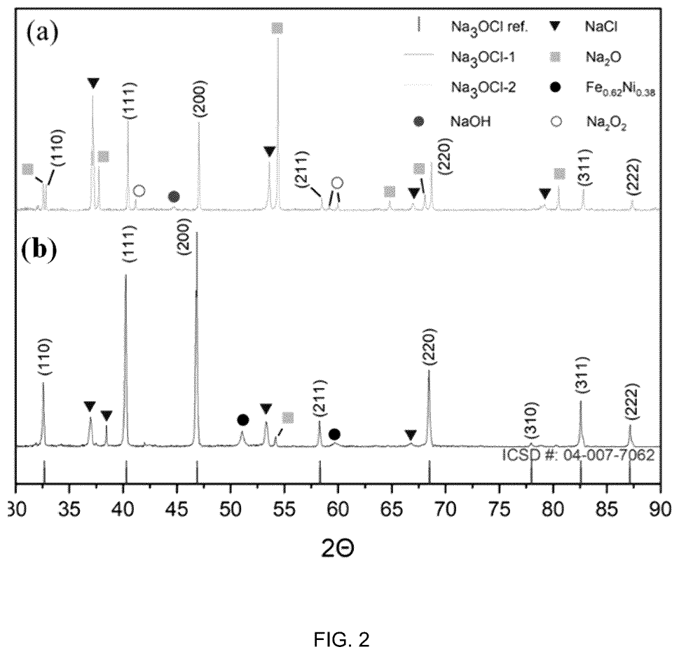

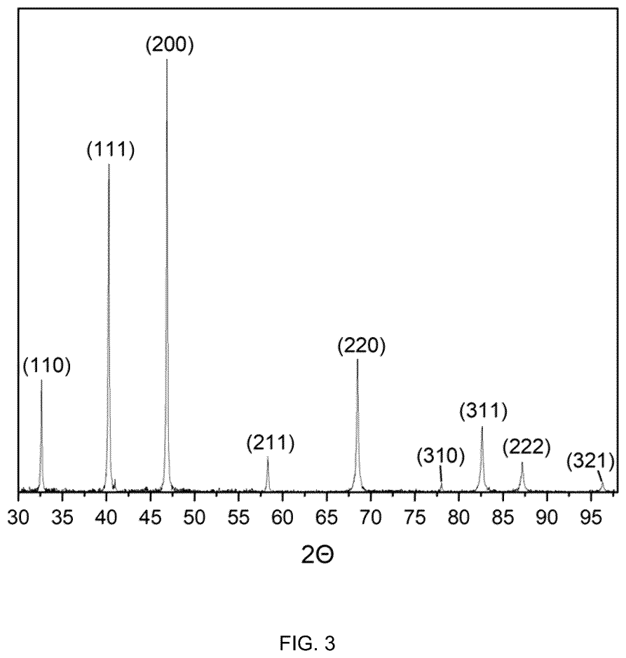

FIG. 2 illustrates the XRD spectrum of Na₃OCl synthesized in conventional vacuum environment where (a) trial 1 is compared with synthesis using microwave radiation without adjustment of the stoichiometric ratio (b) trial 2. Compared to the synthesis in vacuum in trial 1, the current disclosure demonstrates a new method of glass-ceramic electrolyte using microwave radiation which is cost-effective and results in high purity of the synthesized materials. This statement is supported by the examples of sodium oxyhalide glass-ceramic electrolyte synthesis using microwave radiation as shown in FIGS. 2 and 3. FIG. 3 illustrates XRD pattern for Na₃OCl synthesized by using microwave radiation in trial 3. The absence of impurity peaks confirms >99 wt. % purity of the synthesized samples.

In the initial microwave radiation trial 2, Na₂O and NaCl were used in a 1:1 mole ratio according to Eq. 1

$${Na}_{2} O + NaCl \to {Na}_{3} OCl \qquad Eq . 1$$

However, the XRD analysis showed presence of NaCl impurity after exposure to microwave radiation, as shown in FIG. 2. The XRD analysis of the inorganic precursors (Na₂O and NaCl) revealed low Na₂O purity (92.4 wt. %). To achieve the stoichiometric ratio, the amount of NaCl was decreased accordingly with the final mole ratio of Na₂O to NaCl of 1:0.88. XRD analysis of subsequent microwaved samples with decreased amount of NaCl indicated consistent >99% purity of Na₃OCl across multiple batches, as shown in FIG. 3.

TABLE 1
Comparison of chemical composition of
Na₃OCl synthesized in three different trials.

| Compound | Trial 1 (Vacuum) | Trial 2 (wt. %) | Trial 3 (wt. %) |
|---|---|---|---|
| Na₃ClO | 28.0 | 84.4 | >99% |
| NaCl | 31.9 | 9.1 | — |
| Na₂O | 31.3 | 1.8 | — |
| Na₃ClO | — | — | — |
| Na₂O₂ | 4.4 | — | — |
| NaOH | 4.4 | — | — |

### Electrochemical Testing

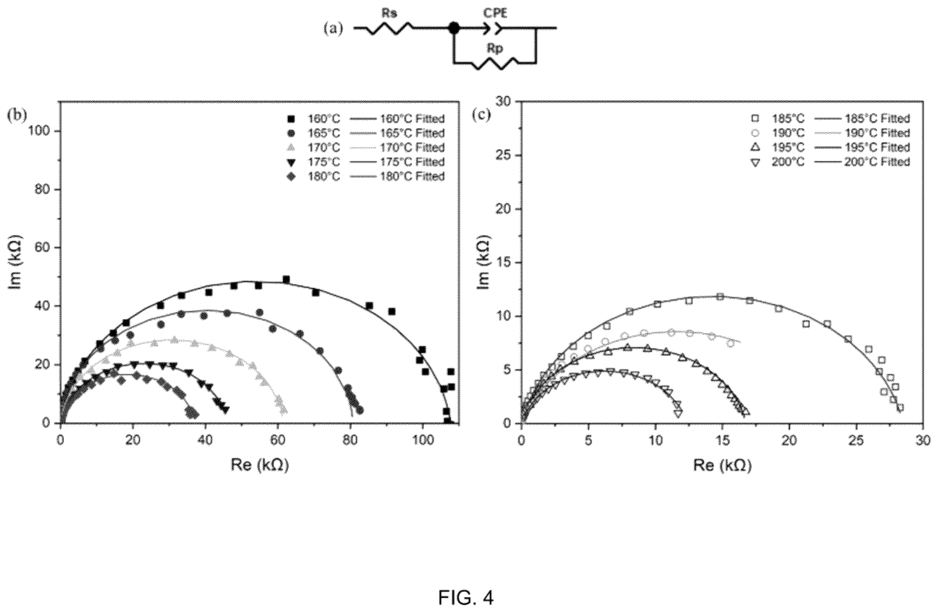

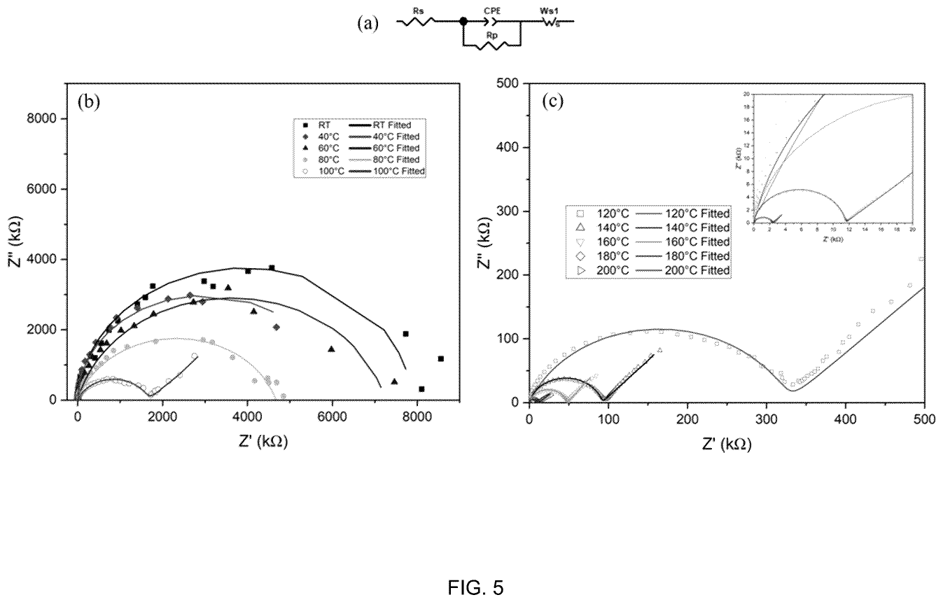

To quantify the internal resistance of synthesized electrolytes, AC impedance tests, as shown in FIGS. 4 and 5, were conducted using symmetric pouch cells. The samples in trial 1, 2, and 3 as shown in Table 1 were compared. Table 1 illustrates the comparison of chemical composition of Na₃OCl synthesized in three different trials. In trial 1 Na₃OCl was synthesized in vacuum, in trial 2 Na₃OCl was synthesized in a microwave radiation environment using commercial inorganic precursors, and in trial 3 Na₃OCl was synthesized in a microwave radiation environment in which the mass of the commercial inorganic precursors was adjusted based on stoichiometric ratio. FIG. 4 illustrates (a) an equivalent circuit for symmetrical pouch cell with Na₃OCl solid-state electrolyte (Trial 1) and graphite-coated copper foil as blocking electrodes. AC Impedance spectra for Na₃OCl symmetrical cell at varying temperatures from (b) 160° C.-180° C. and (c) 185° C.-200° C. FIG. 5 illustrates AC impedance data of microwave-synthesized Na₃OCl at various temperatures in symmetric Na₃OCl pouch cells with (a) equivalent circuit for symmetric pouch cell with Na₃OCl and copper/carbon foil as the blocking electrodes. Warburg element was excluded from impedance spectra where Warburg impedance was not observed, and (b) Room temperature to 100° C., and (c) 120° C. to 200° C.

The Na₃OCl samples synthesized in vacuum, trial 1, have no semicircles and absence of sodium-ion charge transfer below 160° C., as shown in FIG. 4, due to high concentration of impurities. It is also evident that Warburg impedance is absent in these spectra due to limited sodium-ion diffusion.

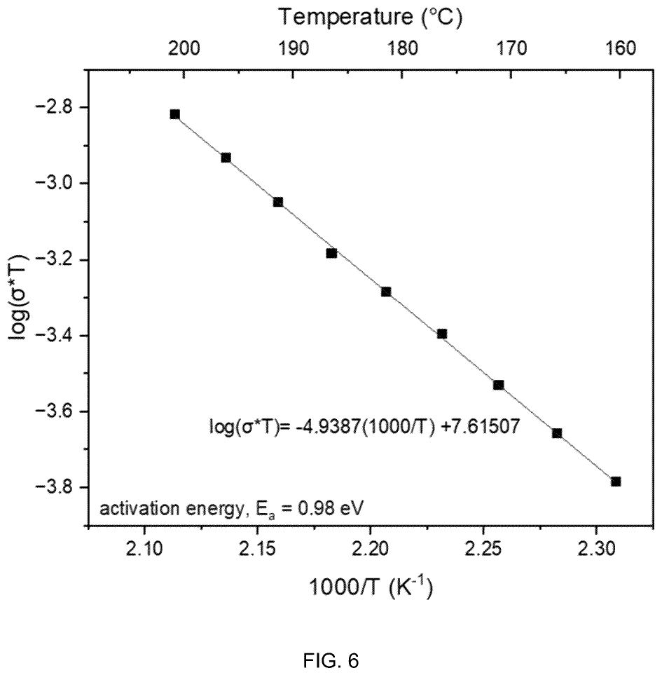

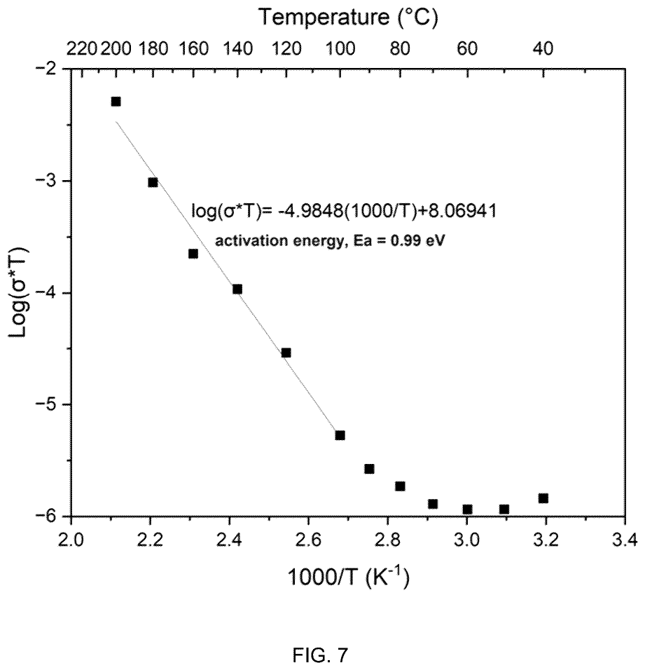

On the contrary to vacuum-synthesized samples in trial 1, as shown in FIG. 4, the microwave synthesis of Na₃OCl in trial 2, as shown in FIG. 4, resulted in much higher yield, less amount of by-products, and higher sodium-ion conductivity. The data for these samples was observed even at room temperature, as shown in FIG. 5, while vacuum-synthesized electrolytes demonstrated the impedance response only at 160° C. and higher. Warburg impedance was also observed at 100° C. and higher which allows calculation of diffusion coefficients of sodium-ions, as shown in FIG. 6. FIG. 6 illustrates Arrhenius plot for vacuum-synthesized Na₃OCl in symmetric pouch cell with carbon-coated copper foil as the blocking electrodes. In one example, the activation energy (Ea) was calculated from the linear slope (m) using the equation: log (σT)=−Ea/kT where m=−Ea/2.303R and R is the molar gas constant. FIG. 7 illustrates Arrhenius plot for the microwave-synthesized Na₃OCl in a symmetric pouch cell with carbon-coated copper foil as the blocking electrodes. The activation energy (Ea) was calculated from the slope (m) of the linear section of the plot using the equation: log (σT)=−Ea/kT where m=−Ea/2.303R and R is the molar gas constant

Table 2 shows the values of ionic conductivity calculated from the fitted model of the experimental resistances from FIG. 4. The Arrhenius behavior, as shown in FIG. 6, was observed for Na₃OCl between 160° C. and 200° C. The calculated activation energy of the vacuum-synthesized Na₃OCl was 0.98 eV. This value was determined from the slope of the linear trend line of the Arrhenius plot. Previous studies have determined the activation energy of Na₃OCl as 1.04 eV8 and 0.63 eV6. The differences in calculated activation energies in previous studies and the value reported here can be attributed to the differences in electrolyte pellet preparation and measurement parameters during impedance testing.

Compared to the vacuum-synthesized material, the results for the microwave synthesis resulted in much lower resistances. Specifically, 108 kΩ resistance was observed for the vacuum-synthesized Na₃OCl electrolyte at 160° C., while microwave-synthesized samples demonstrated only 50 kΩ resistance at the same temperature. Furthermore, the microwave-synthesized electrolyte demonstrated measurable resistance at 100° C. (1.8 MΩ) with distinct Warburg response allowing for calculation of sodium-ion diffusion coefficients.

TABLE 2
Conductivity of Na₃OCl synthesized in vacuum (Trial
1). The conductivity was calculated from the
fitted data of the experimental impedance.

| Temperature | Temperature | Conductivity | 1000/T | |
|---|---|---|---|---|
| (° C.) | (K) | (S/cm) | (1/K) | log(σ*T) |
| 160 | 433.15 | 3.79E−07 | 2.30867 | −3.7842 |
| 165 | 438.15 | 5.01E−07 | 2.28232 | −3.65827 |
| 170 | 443.15 | 6.66E−07 | 2.25657 | −3.53019 |
| 175 | 448.15 | 8.96E−07 | 2.2314 | −3.3963 |
| 180 | 453.15 | 1.15E−06 | 2.20677 | −3.28315 |
| 185 | 458.15 | 1.43E−06 | 2.18269 | −3.18309 |
| 190 | 463.15 | 1.94E−06 | 2.15913 | −3.04745 |
| 195 | 468.15 | 2.50E−06 | 2.13607 | −2.93206 |
| 200 | 473.15 | 3.22E−06 | 2.11349 | −2.81677 |

### CONCLUSIONS

The demonstrated synthesis of glass-ceramic solid-state electrolyte using commercially available inorganic precursors in a microwave radiation environment demonstrated >99% yield at short synthesis times. The tested strategy results in high sodium-ion conductivity compared to conventional synthesis of this material in vacuum. Based on the results obtained for sodium oxyhalide, the disclosure provides a clear path for synthesis of other doped and undoped lithium and sodium halide and oxyhalide superionic conductors. This disclosure provides a cost-efficient and efficient way for manufacturing solid-state inorganic electrolytes for solid-state batteries relevant in different applications, such as medical, portable, automotive, military, and electric power grids.

The disclosure is not to be limited to the particular aspects described herein. In particular, the disclosure contemplates numerous variations in engineering of glass-ceramic solid-state electrolytes with antiperovskite crystal structure in the microwave radiation environment. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions can be made, which are within the intended spirit and scope of the disclosure.

What is claimed is:

1. A microwave radiation system for synthesizing glass ceramic solid-state electrolytes, the system comprising:
at least two solid-state electrolyte precursors, a weight of each of the at least two precursors adjusted by a stoichiometric ratio of the at least two precursors;
a container for combining the at least two precursors to form a powder from the at least two precursors;
a crucible for holding the powder; and
a microwave for heating the crucible to form a solid-state electrolyte material.

2. The microwave radiation system of claim 1, further comprising:
a pellet die for combining the solid-state electrolyte material with a foil to form a positive electrode.

3. The microwave radiation system of claim 2, further comprising:
a cell configuration comprising the first positive electrode formed from the solid-state electrolyte material and a negative electrode, wherein the negative electrode comprises at least a metal foil.

4. The microwave radiation system of claim 1, wherein the microwave utilizes a frequency range of 300 GHz to 300 MHz and oscillating microwave radiation.

5. The microwave radiation system of claim 1, further comprising:
a gas glovebox, wherein the microwave is housed within the gas glovebox.

6. The microwave radiation system of claim 1, wherein the powder is heated at a temperature range of 350° to 450° C.

7. The microwave radiation system of claim 1, wherein the powder is microwaved under nitrogen.

8. A method for synthesizing glass ceramic solid-state electrolytes utilizing microwave radiation; the method comprising:
weighing at least two solid-state electrolyte precursors;
combining the at least two solid-state electrolyte precursors in container with a grinding media;
grinding the at least two solid-state electrolyte precursors to form a powder;
transferring the powder to a crucible;
microwaving the crucible in a microwave, wherein a frequency of the microwave is tuned to form a product; and
sifting the product to form a solid-state electrolyte material.

9. The method of claim 8, further comprising:
transferring the solid-state electrolyte material to a pellet die;
placing a foil in the pellet die; and
heating the pellet die while applying pressure to the solid-state electrolyte and foil to combine the solid-state electrolyte and foil to form a positive electrode.

10. The method of claim 9, further comprising:
placing the positive electrode in a cell; and
placing a negative electrode in the cell.

11. The method of claim 8, wherein the microwave is housed in a gas glovebox and wherein the crucible is microwaved under a gas.

12. The method of claim 8, wherein a weight of each of the at least two solid-state electrolyte precursors adjusted by a stoichiometric ratio of the at least two solid-state electrolyte precursors.

13. The method of claim 8, wherein the solid-state electrolyte material comprises antiperovskite.

14. The method of claim 8, wherein the frequency of the microwave is turned to a range of 300 GHz to 300 MHz.

15. A microwave radiation system for synthesizing glass ceramic solid-state electrolytes, the system comprising:
at least two solid-state electrolyte precursors, wherein the precursors are ground to a powder;
a crucible for holding the powder;
a microwave for heating the crucible holding the powder by applying microwave radiation at a controlled temperature range for a time period, wherein the heating transforms the powder into a solid-state electrolyte material; and
a gas glovebox housing the microwave; the gas glove box supplying gas to an interior of the gas glove box.

16. The microwave radiation system of claim 15, wherein the gas is nitrogen or argon.

17. The microwave radiation system of claim 15, wherein the microwave comprises a temperature controller for controlling the controlled temperature range.

18. The microwave radiation system of claim 15, wherein the solid-state electrolyte precursors are inorganic.

19. The microwave radiation system of claim 15, wherein the temperature range is 350° C. to 450° C. and the time period is 1 hour.

20. The microwave radiation system of claim 15, wherein the gas glove box is an argon glovebox or a nitrogen glovebox.
